(19) United States
(12) Patent Application Publication
(10) Pub. No.: US 2023/0146560 A1
(43) Pub. Date: May 11, 2023

(54) PROCESS OF MAKING AN OBJECT USING AN ADDITIVE MANUFACTURING DEVICE, ADDITIVE MANUFACTURING DEVICE, AND CORRESPONDING COMPUTER PRODUCT

(71) Applicant: Marco ZANI, Cesena FC (IT)

(72) Inventor: Marco ZANI, Cesena FC (IT)

(21) Appl. No.: 17/915,314

(22) PCT Filed: Apr. 1, 2021
(86) PCT No.: PCT/IB2021/052727

§ 371 Date: Sep. 28, 2022

(30) Foreign Application Priority Data
Apr. 3, 2020 (IT) 102020000007129

(51) Int. Cl. B29C 64/393; B29C 64/205; B29C 64/227

(52) U.S. Cl. CPC B29C 64/393; B29C 64/205; B29C 64/227; B33Y 10/00

(57) ABSTRACT

Described is a method for making an object using an additive manufacturing device comprising actuators which act in conjunction to make the object. The method includes:
receiving a design of the object, the design including at least one three-dimensional representation of the object,
receiving at least one construction parameter indicating a physical characteristic of the object to be made,
extracting from a memory at least one value associated with said at least one construction parameter and/or associated with the three-dimensional representation of the object, said at least one value indicating a command which can be set for the actuators of the additive manufacturing device,
modifying the design of the object as a function of said at least one extracted value,
generating a set of commands as a function of said design, and
controlling said actuators by means of said set of commands.

### TECHNICAL FIELD

This invention relates to the technical sector of the methods for making objects by means of additive manufacturing devices, for example 3D printers.

### BACKGROUND ART

Conventionally, these devices for the making of three-dimensional objects receive a file containing a 3D representation of the object to be made generated by a user and defined on the basis of his/her technical knowledge and on the basis of his/her experience with a use of the additive manufacturing devices or of designs with traditional production machines.

It should be noted that, to date, the file which receives the device for making the three-dimensional object is a file of the “.gcode” type obtained using programs known as “slicing” programs.

These “slicing” programs, starting from a 3D geometry supplied by the user, make it possible to modify a series of settings which allow the successful outcome of the part by means of additive manufacturing.

A user needs specialised training to learn to use these programs and this requires a considerable amount of time and money, a large number of field tests, and even failures.

### AIM OF THE INVENTION

In this context, the technical purpose which forms the basis of the invention is to provide a method for making three-dimensional products and a respective additive manufacturing device which helps overcome one or more of the above-mentioned drawbacks of the prior art.

An aim of the invention is to provide a method for making objects and an additive manufacturing device which is easy to use, which allows a use of the device minimising a need for costly training courses, thus allowing the use of this technology even by individuals who are not able to support the above-mentioned investments.

A further aim of the invention is to make an object using the additive manufacturing device, automatically optimising one or more variables which a user currently has to set according to his/her experience. Moreover, an aim of the invention is to provide an object using the additive manufacturing device by adding additional calculation functions intrinsic to the device which allow on the basis of the information present on a memory to find the best printing solution possible, reducing the possibility of error by the user.

The technical purpose indicated and the aims specified are substantially achieved by a method for making objects comprising the technical features described in one or more of the appended claims.

### BRIEF DESCRIPTION OF THE DRAWINGS

Further features and advantages of the present invention are more apparent in the non-limiting description of a preferred embodiment of it, as illustrated in the accompanying drawings, in which:

FIG. 1 illustrates an example block diagram of an additive manufacturing device according to one or more embodiments, and

FIG. 2 shows a non-limiting example of a chamber for three-dimensional making of an additive manufacturing device according to one or more embodiments, and

FIG. 3 shows a flow diagram of a method according to one or more embodiments,

FIGS. 4 to 8 show examples of objects which can be made using the method according to one or more embodiments.

### DETAILED DESCRIPTION OF PREFERRED EMBODIMENTS OF THE INVENTION

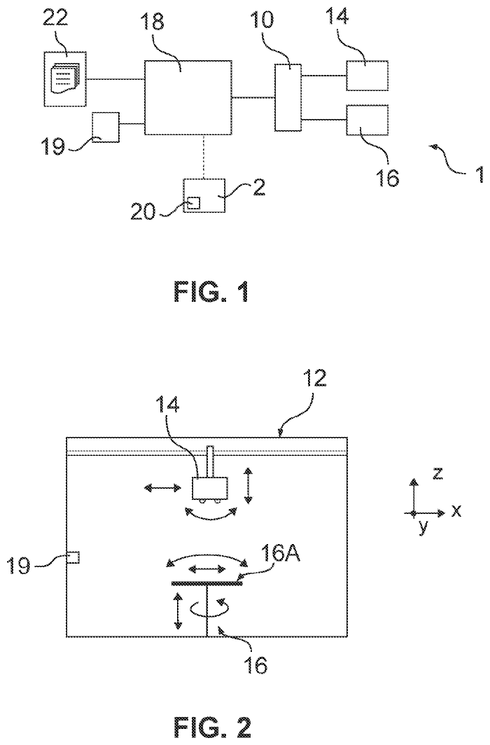

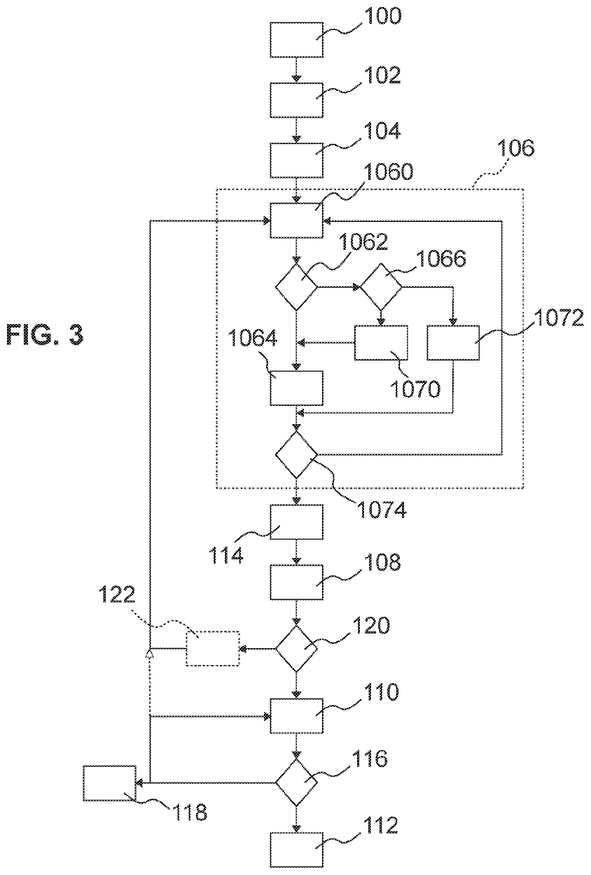

An additive manufacturing device 1 is illustrated schematically in FIGS. 1 and 2, for example a 3D printer configured for printing a three-dimensional object through additive manufacturing. The device 1 comprises:
one or more elements 14 for depositing material configured for placing the material in layers, for example one or more heads configured for depositing different materials,
a supporting surface 16,
a plurality of actuators 10 respectively configured for controlling the one or more elements 14 for depositing material and for moving the supporting surface 16, and
a control unit 18 configured to perform the steps of the manufacturing process according to one or more embodiments.

During the making of the object, said at least one depositing elements 14 and the supporting surface 16 can be controlled preferably simultaneously by the control unit 18. In other words, the one or more depositing elements 14 and the supporting surface 16 may be configured to operate in conjunction for making the object.

The element 14 for depositing material can comprise at least one extruder. During the making of the object, the extruder 14 may be actuated and material escapes from a nozzle of the extruder. The actuators 10 can control the extruder 14 in such a way as to make the object by layering the extruded material.

Alternatively, the depositing element 14 may comprise a MIG/MAG welding torch or a device which is able to deposit material comprising carbon fibre with a polymeric matrix.

The depositing element 14 and the supporting surface 16 can be controlled by the actuators 10 which may comprise, for example, a plurality of electric motors actuated by the control unit 18 during the making of the object. Preferably, during the making of the object, the depositing element 14 and the supporting surface 16 can be controlled simultaneously.

As illustrated in FIG. 2, the additive manufacturing device 1 may comprise a chamber 12 inside of which the object is made. The one or more depositing elements 14 and the supporting surface 16 are located inside the chamber 12.

The depositing element 14 and the supporting surface 16 may be configured to move inside a system of Cartesian axes comprising a first longitudinal direction X, a second sideways direction Y and a third vertical direction Z, as illustrated by the arrows in FIG. 2. The depositing element 14 and/or the supporting surface 16 can each have 6 degrees of freedom of movement.

For example, the depositing element 14 may be configured to move along the first, second and/or third direction X, Y, Z and to rotate about axes parallel to the first and/or second direction X, Y. For example, the supporting surface 16 may be configured to translate along the first, second and/or third direction X, Y, Z and rotate about axes of rotation parallel to the second and/or third direction Y, Z. Advantageously, the rotation about the axis Y allows an inclination of the supporting surface 16 relative to the third vertical axis Z. The supporting surface 16 may be configured to move continuously during the making of the object, for example oscillating in order to facilitate the making of the object.

Advantageously, a movement of the element 14 for depositing material and of the supporting surface 16 may allow a creation of trajectories for depositing material which are not affected by the constraints of traditional machines; the making of the object, the distribution of material and, if necessary, a continuous fibre, occurs in a completely different manner to that of the prior art machines.

Advantageously, the movement of the supporting surface 16 and of the depositing element 14, preferably simultaneously, facilitates an optimum embodiment of the object, as it facilitates a physical making of trajectories and geometries present in the design.

Advantageously, the presence of one or more supports 24 may be excluded thanks to the movement of the supporting surface 16 and the depositing element 14.

The additive manufacturing device 1 may comprise a sensor 19, preferably an image acquisition device and/or a movement sensor, connected to the control unit 18 and configured for transmitting to the control unit 18 a signal indicating the embodiment of the object in progress. The sensor 19 may be inside or at the chamber 12. Advantageously, the sensor 19 makes it possible to perform a real-time analysis of a congruence of the design with the physical production in progress of the object.

According to one aspect, through the signal received from the sensor 19, the control unit 18 may be configured to detect a presence of an error during making of the object. For example, if the sensor 19 is an image acquisition device, the control unit 18 can detect an error during making through a method for recognising objects inside an image received from the image acquisition device.

The additive manufacturing device 1 may also comprise a memory 22, connected to the control unit 18. The memory 22 may comprise a plurality of values indicating a command sent to the actuators of the device 1. In addition or alternatively, the memory 22 may comprise a plurality of construction parameters indicating the physical characteristics of the object to be made. Preferably, these construction parameters are associated, in the memory 22, with one or more values.

The memory 22 is preferably a database comprising a plurality of associations between a plurality of construction parameters and a plurality of values. For example, each construction parameter may have one or more associations with one or more values, and vice versa.

The data in the memory 22 can be preloaded and/or may be determined as a function of analysis of previous designs and/or as a function of characteristics of each material.

One or more embodiments may refer to an information technology product which can be loaded in the memory of at least one processor, for example the control unit 18, and comprising portions of software code configured to perform the steps of the method according to one or more embodiments as described below.

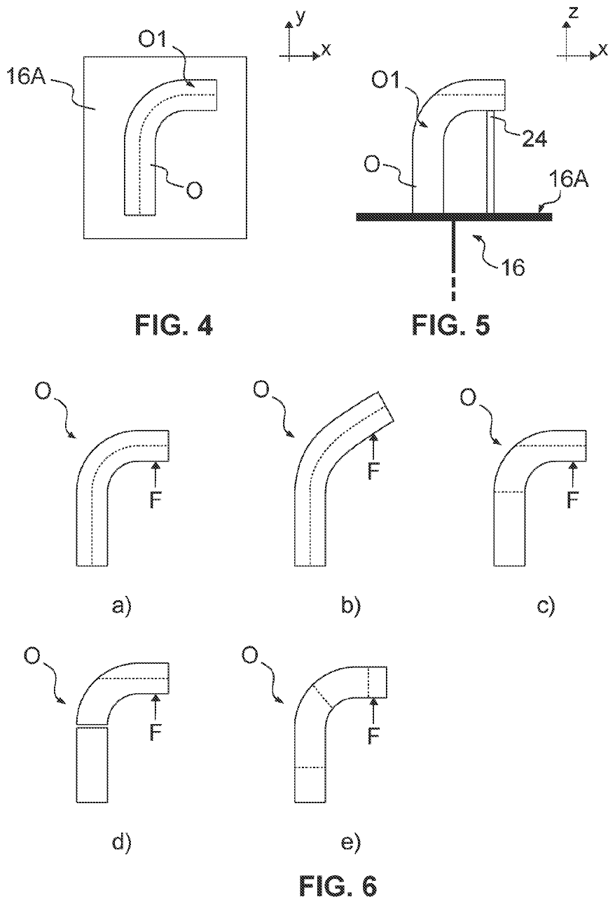

According to one or more embodiments, as illustrated in FIG. 3, the method comprises:
100, receiving a design of the object, the first design comprising at least one three-dimensional representation of the object or a three-dimensional technical drawing,
102, receiving at least one construction parameter indicating a physical characteristic of the object to be made,
104, extracting from a memory 22 at least one value associated with the at least one construction parameter and/or associated with the three-dimensional representation of the object, where the value indicates a command which can be set for the actuators of the additive manufacturing device 1,
106, modifying the design of the object as a function of said at least one extracted value,
108, generating a set of commands, for example a print file, as a function of the modified design, and
110, controlling the actuators 10 by means of the set of commands, for example making the object by controlling the supporting surface 16 and the depositing element 14.

The design comprises a three-dimensional representation, for example graphical, of the object or a three-dimensional CAD (Computer-Aided Design) technical drawing in a format which can be processed by the device 1. The device 1 may receive a file comprising the first design with the 3D drawing of the object.

The design may also comprise further features associated with the making of the object, for example a position of the object inside the chamber 12, orientation of the object to be placed inside the chamber 12, a definition of the filling and the direction of depositing the object. For example, if the design comprises a three-dimensional representation of a cube, a physical characteristic of the cube may comprise a direction of layering of material for making the object (for example, each layer can have right-angle lines relative to an adjacent layer) or one or more materials for making the object.

The first design received may comprise exclusively the three-dimensional representation. The physical characteristics of the object can be calculated and introduced in the design during the performance of the method according to the one or more construction parameters received.

According to one aspect, the method may comprise one or more post-processing steps 112, for example following the making or printing of the object, for modifying the object made and/or for removing supports. Examples of post-processing may comprise removal of material by mechanical removal, removal by means of solvents and/or application of surface treatments or application of threaded bushes and/or traditional mechanical processing.

According to one aspect, the device 1 may be connected to a processing unit 2, for example a computer, comprising a display unit 20. A user can enter in the processor 2 a plurality of construction parameters, for example through dropdown menus or sequence of requests displayed on the display unit 20, and the processor 2 can transmit said construction parameters to the control unit 18 of the device 1. For example, the display unit 20 can display the three-dimensional representation of the object and the user can enter the construction parameters on the three-dimensional representation, where applicable. For example, the force applicable to the object may be indicated on the graphical representation.

According to one aspect, the method may comprise a step 114 of transmitting to the display unit 20 the modified design, for example before generating 108 the set of commands, for displaying the modified design.

According to one aspect, the step of controlling 110 the actuators 10 may comprise moving the supporting surface 16, by means of the actuators 10, in such a way as to translate along the third direction Z and/or rotate the supporting surface 16 during the making of the object.

Optionally, the actuators 10 can move the supporting surface 16 with an oscillating movement. For example, the oscillating movement may be about an axis of rotation parallel to the second direction Y, that is, the oscillation may result in an inclination of the supporting surface 16 relative to the third vertical direction Z.

In addition or alternatively, the actuators 10 can move the supporting surface 16 and keep it static in a working position different to the rest position during the making of the object.

According to an aspect, the step of controlling 110 the actuators 10 comprises controlling at least one element 14 for depositing material and moving the supporting surface 16, by means of said actuators 10, simultaneously during the production of the object, preferably rotating the supporting surface 16.

According to one or more embodiments, the construction parameters may indicate how the object is made, for example by printing, and/or what the object is like once made. The construction parameters may comprise one or more of the following:
a portion of the object on which a predetermined force can be exerted (shear, tearing, tensile, compression, twisting etc.), for example if the object is subjected during use on one side to a force along a predetermined direction and a particular resistance of the side to that force is desirable,
a weight of the object, for example a weight of an object made which falls within a predetermined range,
a finishing of at least one side of the object, for example a smooth or rough side,
a dimensional tolerance of at least one portion of the object, for example if there is a hole in the object which is unattractive but functional,
a mechanical, electrical, chemical and/or thermal property of the object,
an end use of the object, for example if the object is to be used in a sector which requires precise embodiments, for example automotive, mechanical, aerospace, naval, industrial automation, medical, motorsport, fashion, design etc.,
a portion of the object which can be exposed to predetermined atmospheric conditions, for example adverse or extreme conditions, for example, extreme heat or cold,
a speed of generating the final object, for example, if it were desirable to make one or a plurality of objects in series; a production time could, for example, avoid the use of soluble supports or other types of post-processing,
if the printed object could be subjected to post-processing, for example removal of material using numerical control machines (CNC) or manual machines, such as a drills, painting machines, sandblasting machines, etc.

For example, in a use in the naval sector, the object could be subject to atmospheric agents such as erosion and/or salinity; in use in the automotive sector, it is desirable that the object is resistant to hydrocarbons.

According to one or more embodiments, the values stored in the memory 22 may indicate one or more of the following:
a direction of layering layers of the object during the depositing of material, for example whether to deposit from the outside towards the inside, whether to modify a direction of depositing material between adjacent layers, and/or
a length of filaments deposited, for example filaments made of molten material and/or reinforcement filaments made of glass fibre, carbon, aramid fibre (such as Kevlar) or other material, and/or
a filling of the object and relative geometry, for example how the material deposited distributes on each layer of the object in order to minimise the presence of holes or unwanted shapes in the finished object, and/or
a choice of material for producing the object, and/or
a quantity of material to be used during production, for example whether a thickness of the filaments deposited on the outer sides of the object must be thicker than a thickness of the deposited filaments which make up the inside of the object; and/or
a speed of movement of the actuators 10, and/or
a speed of depositing material, and/or
a presence of supports during the production of the object, and/or
a temperature of the depositing material, for example a high temperature can obtain a greater seal between adjacent layers of material, a low temperature can minimise running of material.

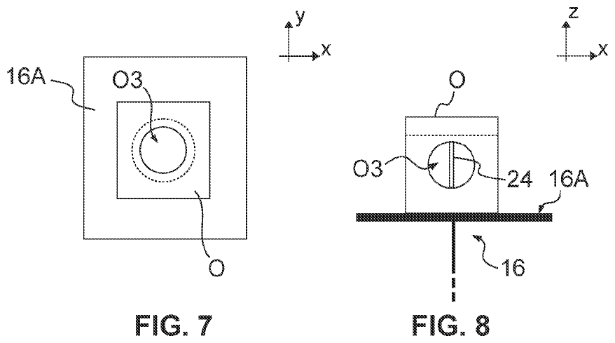

For example, if a first object O has an aesthetic purpose and it is therefore desirable that a side O1 has a particularly smooth finish, the control unit 18 may be configured for extracting, as a function of the finishing of the side O1 of the object, the suitable layering direction, in such a way that the side O1 is parallel to a surface 16A of the supporting surface 16, as illustrated in FIG. 4. In this way, the growth follows a curve of the first object O, as illustrated by the dashed line in the drawing, and each layer is stacked along a direction perpendicular to the supporting surface 16, for example along the third vertical axis Z. Alternatively, as illustrated in FIG. 5, if the side O1 is not parallel to the surface 16A of the supporting surface 16, the layering direction may be performed parallel to the surface 16A, as illustrated by the dashed line in FIG. 5, and the side O1 might have a layering of material which is more visible and consequently less smooth at the curve of the first object O.

For example, the control unit 18 may be configured to extract from the memory 22 values indicating the use of one or more supports 16, configured to support the material deposited during making of the object, for example as a function of a geometry of the object contained in the first design. The examples of FIGS. 4 and 5 show a support 24 used to make the first object O of FIG. 5. In fact, at the height of the curve, the material deposited can rest on the support 24; if there were no support 24, the shape of the object O would not be achievable through this type of layering since it could cause a production error.

The use of a support 24 may be associated with a post-processing of the object O; for this reason, the control unit 18 may be configured to extract values indicating a use of supports, for example the control unit 18 may be configured for:
if post-processing is excluded or undesirable, excluding the presence of supports 24,
modifying the design by introducing one or more supports 24 and of the material: if the materials are similar or equal to a material of the object O, a removal is more difficult, however the object O has a better finish; on the contrary, a support 24 made of a different material is easy to remove but may result in defects at a surface of contact between the support 24 and the object O,
modifying the design by introducing a soluble support: the object made has a good finish, however a washing is necessary after making the supports 24, with consequent additional costs and a longer production time,
if several different materials are used during printing, modifying the design by introducing one or more secondary towers, for example material purging towers.

For example, if the presence of supports 24 is excluded, the control unit 18 may be configured to rotate the supporting surface 16. Advantageously, in this way, it is possible to make shapes of the object O without support, which it would be conventionally possible to make only through the presence of a support.

The control unit 18 may be configured to modify the design by introducing dimensions, position and inclination of the one or more supports 24.

For example, it is possible to assess the use of a brim or raft as a function of a type of material selected for making the object and/or as a function of a geometry of the object to be made, for example to facilitate an adherence of the object O to the supporting surface 16.

For example, if a portion of the object O is subjected to a predetermined force F, as illustrated in FIG. 6, it is desirable for the object O to resist the force F without breaking. The control unit 18 may be configured to extract from the memory 22 the appropriate layering direction during the depositing of material as a function of the force F which can be imposed on the portion of the object. For example:
as illustrated in FIG. 6 portions a) and b), if the layering direction follows the curve of the object O, the object O subjected to the force F can be deformed,
as illustrated in FIG. 6 portions c) and d), if the layering direction is parallel to the supporting surface 16 as illustrated in FIG. 5, parts of the object O subjected to the force F detach one from the other and the object O breaks, since the force F would be applied to a seal between the various layers of the object O,
as illustrated in FIG. 6 portion e), if the layering direction is perpendicular in each point to a side O2 of the object O, the object O is able to withstand the force F.

In the latter case, the perpendicular layering direction at each point to the side O2, including a curve of the side O2, is possible thanks to the possibility of simultaneously moving the depositing element 14 and the supporting surface 16.

For example, the weight of the object and/or the resistance of the object to forces may be associated with a production time and/or a quantity of material. In fact, a lighter object O can be printed more quickly with a reduced quantity of material, however the object made would not be very resistant. On the other hand, a heavy object may require a longer production time and a greater quantity of material, however the object made would be more resistant.

For example, a printing speed may be inversely proportional to a precision in making the object O.

For example, a quantity of material to be used during production may influence a resistance, a production speed, a tolerance and/or an appearance of the object O. In fact, the greater the quantity of material deposited, the thicker the layers of material will be, the faster it will be to make and the more resistant the object O will be. However, a large quantity of material may be linked to a low tolerance of parts of the object O with respect to a geometry of the graphical representation, an aesthetically less precise object and a use of supports 24 may be more difficult in terms of management and their removal. On the other hand, the lower the quantity of material deposited, the thinner the thickness of the layers will be, the longer the printing time will be, the more aesthetically precise it will be and the less resistant it will be. The presence or absence of supports can be assessed as a function of the thickness of the material to be deposited.

For example, a temperature of depositing material may be associated with a dimension of the object to be made and/or with a resistance of the object to a predetermined force F. In fact, if an object is thin and/or small in size a lower temperature may be preferable, if the object is subjected to a force F a higher temperature may be preferable since a layering of material has greater possibility of sealing.

For example, the temperature of the depositing material may be associated with a use of supports 24, since hotter deposited material may be more difficult to separate from the support, for example because it is better sealed on it, and/or can modify the geometry of the object; on the other hand, colder deposited material may be easier to separate from the support, for example because it is less sealed on it; however, the object made could have defects in the sealing of the various layers and/or can exhibit a reduced quantity of material.

For example, a dimensional tolerance may be associated with a direction of layering; in fact, if the object O has a hole O3 with a functional purpose and not one of appearance, it may be desirable to have a high level of precision during depositing. For this reason, see FIG. 7, the hole O3 may be deposited with an inlet opening parallel to the supporting surface 16, so that a shape of the hole is made by depositing material (dashed line in FIG. 7) in such a way that it follows the shape of the hole. On the other hand, see FIG. 8, if the opening of the hole O3 is perpendicular to the supporting surface 16, the hole may be supported by one or more supports 24 to support the hole O3, which may lead to defects, and/or may have steps since the depositing direction (dashed line in FIG. 8) does not follow the shape of the hole O3, which can reduce the tolerance of the hole O3.

According to one aspect, one or more values may indicate a choice of one or more or more materials to be used for making the object. For example, the material may be chosen as a function of the supports 24 and/or depending on an end use of the object O. In fact, the object O may comprise different materials for providing different performances; for example, an object O can imitate a rigid behaviour of a bone together with a flexible behaviour of a ligament. Alternatively, an object O may comprise a translucent material with inside it, inserted, a dark material or an object O may be a shoe which has several materials with different degrees of flexibility. The materials may be plastic, plastic with fillers, flexible and/or comprise a reinforcement of continuous fibre material, for example carbon, Kevlar or the like, which can modify the mechanical performance of the object.

In the latter case, the control unit 18 may be configured for placing a continuous reinforcement thread, without an interruption.

The control unit 18 may be configured for introducing reinforcements, for example carbon fibres, automatically as a function of the construction parameters or upon request by a user.

According to one or more embodiments, the user can also enter in the processor 2 a list of construction parameters, such that elements in the list are in order of decreasing priority, to give an order of importance for defining the constraints of the object. The list of construction parameters may indicate an importance of a particular feature in making the object and/or which production constraints are more important than others. For example, if the object to be made is for an aesthetic purpose, the list of parameters comprises as first elements the construction parameters of an aesthetic type, before elements relative to a mechanical behaviour.

The control unit 18 may be configured for:
120, checking whether at least one between the set of commands and/or the design is compatible with a physical production of the object,
102 or 122, receiving a list of construction parameters, such that elements in the list are in order of decreasing priority,
if at least one between the set of commands and/or the design is not compatible with the physical production of the object, modifying 106 the design as a function of said at least one value and said list of construction parameters.

The control unit 18 may be configured to receive, 102, the list of parameters simultaneously with the design. Alternatively, the control unit 18 may be configured to receive, 122, the list of parameters only after a check on whether at least one of the set of commands and/or the design is not compatible with a physical embodiment of the object.

The step 106 of modifying the design may be carried out as a function of the values extracted and on the list of construction parameters. According to one aspect, the step 106 of modifying the design comprises, for each value extracted from the memory 22:
1060, calculating a modification to the design as a function of the value extracted,
1062, assessing whether the modification to the calculated design is incompatible with the design,
if it is compatible, 1064, modifying the design,
if it is not compatible, 1066, checking whether the incompatibility id the result of a modification performed as a function of another value, different from the value currently considered, extracted from the memory 22 and whether a priority of the working parameter associated with the current value is greater than a priority of the working parameter associated with the other value,
if the priority of the working parameter associated with the current value is greater, 1070, eliminating the modification performed as a function of the other extracted value and 1064, modifying the first design as a function of the calculated modification, and
if the priority of the working parameter associated with the current value is less, 1072 rejecting said calculated modification.

Following the step 1064 to accept the modification or the step 1072 to reject the modification, the control unit 18 may be configured to check, 1074, if all the values extracted from the memory 22 have been used in the calculation of the design modifications. If all the values extracted have been considered, the method continues with the step 114 of displaying the design and/or with the step 108 of generating the set of commands.

In one or more embodiments, the control unit 18 is configured for:
114, receiving from a sensor 19 a signal indicating a production of the object in progress,
116, checking whether a defect in the production of the object is present as a function of the signal received, and
if said defect is detected, 110, controlling the actuators 10 as a function of the defect.

For example, the controlling of the actuators 10 may be adapted as a function of the detected defect, for example by compensating for the defect, or the controlling of the actuators 10 may be interrupted.

In one or more embodiments, the control unit 18 is configured for:
118, associating the defect detected with at least a first value of the memory 22, the first value being a value as a function of which a modification of the design has been performed during the step for modifying the design, and/or
106, recalculating the design of the object also as a function of the defect detected.

The sensor 19 makes it possible to monitor the depositing of material and any errors during production or printing. In this way, if there is an error during the printing step, the error could be associated with the calculated design, for example if the supports 24 are incorrect or the element 14 for depositing material enters into collision with the supporting surface 16, the final production of the part would not be achieved.

In addition, a user can provide, by means of the processor 2, feedback to the control unit 18 relative to the object made, for example if the object has some visible error, if the component has broken in the application and where. The control unit 18 may be designed to associate the feedback with one or more values inside the memory 22.

1. A method for making an object using an additive manufacturing device comprising at least one depositing element configured for placing a material in layers, a supporting surface and actuators for controlling the one or more elements for depositing of material and/or for moving the supporting surface, the method comprising:
receiving a design of the object, the design comprising at least one three-dimensional representation of the object,
receiving at least one construction parameter indicating a physical characteristic of the object to be made,
extracting from a memory at least one value associated with said at least one construction parameter and/or associated with the three-dimensional representation of the object, said at least one value indicating a command which can be set for the actuators of the additive manufacturing device,
modifying the design of the object as a function of said at least one extracted value,
generating a set of commands as a function of said design, and
controlling said actuators by means of said set of commands.

2. The method according to claim 1, comprising:
checking whether at least one between the set of commands and/or the design is compatible with a physical production of the object,
receiving a list of construction parameters, such that elements in the list are in order of decreasing priority,
if at least one between the set of commands and/or the design is not compatible with the physical production of the object, modifying the design as a function of said at least one value and said list of construction parameters.

3. The process according to claim 2, wherein the step of modifying the design comprises, for each value extracted from the memory:
calculating a modification to the design as a function of said value,
assessing whether the modification to the calculated design is incompatible with the design,
if it is compatible, modifying the design,
if it is not compatible, checking whether said incompatibility is a result of a modification performed as a function of another extracted value,
if the incompatibility is the result of a modification performed as a function of said other extracted value, checking whether a priority of the operating parameter associated with said value is greater than a priority of the operating parameter associated with said other value,
if the priority of the operating parameter associated with said value is greater, eliminating the modification performed as a function of said other extracted value and modifying the first design as a function of the calculated modification, and
if the priority of the operating parameter associated with said value is less, rejecting said calculated modification.

4. The machine according to claim 1, comprising:
receiving from a sensor a signal indicating a production of the object in progress,
checking whether a defect in the production of the object is present as a function of the signal received, and
if the defect is detected, controlling said actuators as a function of said defect detected.

5. The method according to claim 4, comprising:
associating said defect detected with at least a first value of the memory, said first value being a value as a function of which a modification of the design has been performed during the step for modifying the design, and/or
recalculating the design of the object also as a function of said defect detected.

6. The method according to claim 1, wherein the step of controlling said actuators comprises moving a supporting surface by means of said actuators, in such a way as to translate and/or rotate the supporting surface during production of the object, preferably with an oscillating movement.

7. The method according to claim 6, wherein the step of controlling said actuators comprises controlling at least one element for depositing material and moving the supporting surface, by means of said actuators, simultaneously during the production of the object, preferably rotating the supporting surface.

8. The method according to claim 1, comprising receiving at least one construction parameter, including:
a portion of the object on which a predetermined force can be exerted,
a weight of the object, and/or
a finishing of at least one side of the object, and/or
a dimensional tolerance of at least one portion of the object, and/or
a mechanical, electrical, chemical and/or thermal property of the object, and/or
an end use of the object, and/or
a portion of the object configured to be exposed to predetermined atmospheric conditions, and/or
a speed of generation of the final object,
whether the moulded object can be subjected to post-processing.

9. The method according to claim 1, wherein said values stored in the memory indicate at least one between:
a direction of layering of layers of the object, and/or
a length of deposited rows, and/or
a filling of the object and relative geometry, and/or
a choice of material for producing the object, and/or
a quantity of material to be used during production of the object; and/or
a speed of movement of the actuators, and/or
a speed of depositing material, and/or
a presence of supports during the production of the object, and/or
a temperature of depositing material.

10. An additive manufacturing device for making an object, comprising:
at least one element for depositing material,
a supporting surface,
a plurality of actuators configured for controlling said at least one depositing element and for moving said supporting surface, and
a control unit configured to perform the steps of the method according to claim 1,
wherein, during the making of the object, said at least one depositing element and said supporting surface can be controlled preferably simultaneously by the control unit.

11. The additive manufacturing device according to claim 10, comprising at least one sensor, preferably an image acquisition device and/or a movement sensor, configured for transmitting to the control unit a signal indicating the production of the object in progress, wherein the control unit is configured for detecting a defect in the production in progress as a function of said signal received.

12. A computer product which can be loaded in the memory of at least one processor and comprising portions of software code configured to perform the steps of the method according to claim 1.
